(19) United States
(12) Patent Application Publication
(10) Pub. No.: US 2025/0020120 A1
(43) Pub. Date: Jan. 16, 2025

(54) SYSTEM FOR DETERMINING SERVICE LIFE OF HYDRAULIC PUMP

(71) Applicant: KAWASAKI JUKOGYO KABUSHIKI KAISHA, Kobe-shi, Hyogo (JP)

(72) Inventors: Akihiro KONDO, Kobe-shi (JP); Yoshifuru OKADA, Kobe-shi (JP); Hiroyasu KODERA, Kobe-shi (JP)

(73) Assignee: KAWASAKI JUKOGYO KABUSHIKI KAISHA, Kobe-shi, Hyogo (JP)

(21) Appl. No.: 18/713,591

(22) PCT Filed: Sep. 13, 2022
(86) PCT No.: PCT/JP2022/034196

§ 371 Date: May 24, 2024

(30) Foreign Application Priority Data
Jan. 20, 2022 (JP) 2022-007036

(51) Int. Cl. F04B 51/00; F15B 19/00

(52) U.S. Cl. CPC F04B 51/00; F15B 19/00

(57) ABSTRACT

A service life determining system for determining a service life of a hydraulic pump driven by a prime mover includes pump control circuitry. The pump control circuitry calculates, each time a predetermined period has elapsed, an equivalent operating time of the hydraulic pump in the predetermined period based on an actual operating time of the prime mover in the predetermined period, a change in a rotation speed of the prime mover in the predetermined period, a change in a delivery pressure of the hydraulic pump in the predetermined period, and a change in a temperature of a hydraulic liquid in the predetermined period.

### TECHNICAL FIELD

The present disclosure relates to a system for determining the service life of a hydraulic pump.

### BACKGROUND ART

Conventionally, there have been known hydraulic pumps that are driven by a prime mover such as an engine or an electric motor. For such a hydraulic pump, there is a case where the manufacturer of the hydraulic pump indicates the service life of the hydraulic pump.

Patent Literature 1 discloses a technique to detect wear of a hydraulic pump although the technique does not determine the service life of the hydraulic pump.

### CITATION LIST

### Patent Literature

PTL 1: Japanese Laid-Open Patent Application Publication No. H07-280688

### SUMMARY OF INVENTION

### Technical Problem

Since the manufacturer indicates the service life of the hydraulic pump on the assumption that the hydraulic pump is used under predetermined conditions, the remaining service life of the hydraulic pump changes significantly depending on the operating conditions of the hydraulic pump.

In view of the above, an object of the present disclosure is to provide a system for determining the service life of a hydraulic pump, the system making it possible to accurately recognize the remaining service life of the hydraulic pump.

### Solution to Problem

The present disclosure provides a system for determining a service life of a hydraulic pump driven by a prime mover, the system including: pump control circuitry that calculates, each time a predetermined period has elapsed, an equivalent operating time of the hydraulic pump in the predetermined period based on an actual operating time of the prime mover in the predetermined period, a change in a rotation speed of the prime mover in the predetermined period, a change in a delivery pressure of the hydraulic pump in the predetermined period, and a change in a temperature of a hydraulic liquid in the predetermined period.

### Advantageous Effects of Invention

The present disclosure provides a system for determining the service life of a hydraulic pump, the system making it possible to accurately recognize the remaining service life of the hydraulic pump.

### BRIEF DESCRIPTION OF DRAWINGS

FIG. 1 shows a schematic configuration of a service life determining system for determining the service life of a hydraulic pump according to one embodiment.

FIG. 2 is a graph showing temporal changes in the rotation speed of a prime mover, the operating amount of an operator, and the delivery pressure of a hydraulic pump in a case where the service life determining system shown in FIG. 1 is mounted to a hydraulic excavator.

FIG. 3A is a graph showing temporal changes in the delivery pressure of the hydraulic pump in one predetermined period.

FIG. 3B is a graph showing, in the form of a histogram, the delivery pressure of the hydraulic pump in the one predetermined period.

FIG. 4A is a graph showing a relationship between a simple average value of the rotation speed of the prime mover in a predetermined period and a first coefficient.

FIG. 4B is a graph showing a relationship between a weighted average value of the delivery pressure of the hydraulic pump in a predetermined period and a second coefficient.

FIG. 4C is a graph showing a relationship between an average value of the temperature of the hydraulic liquid in a predetermined period and a third coefficient.

### DESCRIPTION OF EMBODIMENTS

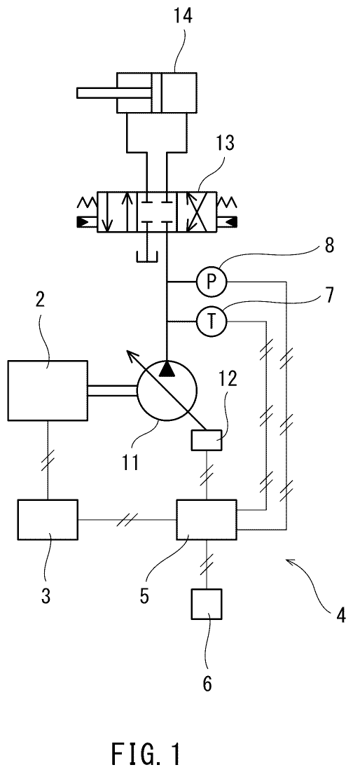

FIG. 1 shows a service life determining system 4 according to one embodiment. The service life determining system 4 is a system for determining the service life of a hydraulic pump 11.

The service life determining system 4 can be mounted to various machines together with the hydraulic pump 11. Examples of a machine to which the service life determining system 4 and the hydraulic pump 11 are mounted include construction machines such as a hydraulic excavator and a wheel loader and industrial machines such as a press machine.

The hydraulic pump 11 is driven by a prime mover 2. The prime mover 2 may be an engine, or may be an electric motor. The hydraulic pump 11 is not limited to a particular type, but may be, for example, any of the following: a vane pump; a gear pump; a screw pump; and a piston pump.

In the present embodiment, the hydraulic pump 11 is a variable displacement axial piston pump (a swash plate pump or a bent axis pump), and the displacement of the hydraulic pump 11 is changed by a regulator 12. Although the minimum displacement of the hydraulic pump 11 is greater than zero in the present embodiment, the minimum displacement of the hydraulic pump 11 may be zero. Alternatively, the displacement of the hydraulic pump 11 may be fixed.

The hydraulic pump 11 supplies a hydraulic liquid to at least one hydraulic actuator 14. Although the hydraulic actuator 14 is a double-acting cylinder in the illustrated example, the hydraulic actuator 14 may be a single-acting cylinder. Alternatively, the hydraulic actuator 14 may be a hydraulic motor.

In the present embodiment, the hydraulic pump 11 is connected to the hydraulic actuator 14 via a control valve 13. In a case where the hydraulic pump 11 is a bidirectional pump whose hydraulic liquid delivery direction is changed in accordance with its rotation direction, the hydraulic pump 11 may be connected to the hydraulic actuator 14 in a manner to form a closed circuit.

The prime mover 2 is controlled by prime mover control circuitry 3. In a case where the prime mover 2 is an engine, the prime mover control circuitry 3 adjusts a fuel injection amount and an engine rotation speed. In a case where the prime mover 2 is, for example, a servomotor, the prime mover control circuitry 3 is a servo amplifier.

The service life determining system 4 includes pump control circuitry 5, a pressure sensor 8, and a temperature sensor 7. The pressure sensor 8 measures a delivery pressure P of the hydraulic pump 11, and the temperature sensor 7 measures a temperature T of the hydraulic liquid. In the present embodiment, the pressure sensor 8 and the temperature sensor 7 are located on a supply line between the hydraulic pump 11 and the control valve 13. Alternatively, the temperature sensor 7 may be located on a tank that stores the hydraulic liquid.

Although not illustrated, an unloading line is branched off from the supply line between the hydraulic pump 11 and the control valve 13, and an unloading valve is located on the unloading line. When the control valve 13 is in its neutral position, the unloading valve is fully open to bring the hydraulic liquid delivered from the hydraulic pump 11 back to the tank through the unloading line. When the control valve 13 shifts from the neutral position, the opening degree of the unloading valve decreases in accordance with a shift amount of the control valve 13. A relief line is branched off from the supply line, and a relief valve is located on the relief line. The relief valve serves to keep the delivery pressure P of the hydraulic pump 11 to less than or equal to a predetermined value.

The pump control circuitry 5 controls the aforementioned regulator 12. The machine to which the service life determining system 4 is mounted includes an operator that is a device to move the hydraulic actuator 14 via the control valve 13. The pump control circuitry 5 controls the regulator 12 to increase the displacement of the hydraulic pump 11 in accordance with increase in the operating amount of the operator.

For example, the operator is an electrical joystick including an operating lever, and the electrical joystick outputs an electrical signal corresponding to an inclination angle of the operating lever to the pump control circuitry 5. The operator may be a pilot operation valve that outputs pilot pressures to respective pilot ports of the control valve 13. In this case, each pilot pressure outputted from the pilot operation valve is measured by a pressure sensor and inputted to the pump control circuitry 5.

Regarding the pump control circuitry 5, the functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

The pump control circuitry 5 transmits and receives various signals to and from the prime mover control circuitry 3. The prime mover control circuitry 3 includes a time meter that measures an actual operating time H of the prime mover 2 (the time meter is usually called “hour meter”). The time meter need not be included in the prime mover control circuitry 3, but may be electrically connected to the prime mover control circuitry 3. Also, the prime mover control circuitry 3 is electrically connected to a rotation speed sensor that measures a rotation speed N of the prime mover 2. The prime mover control circuitry 3 inputs the actual operating time H and the rotation speed N of the prime mover 2 to the pump control circuitry 5.

In the present embodiment, the service life determining system 4 further includes a rotation speed selector 6 for a user to change a setting rotation speed of the prime mover 2. For example, the rotation speed selector 6 is a dial-type selector by which the setting rotation speed can be selected from multiple setting rotation speeds of multiple ranks. The multiple ranks correspond to predetermined rotation speed intervals, respectively. For example, the setting rotation speed of rank 1 is 1000 rpm; the setting rotation speed of rank 2 is 1200 rpm; and the setting rotation speed of rank 6 is 2000 rpm.

The pump control circuitry 5 inputs, to the prime mover control circuitry 3, a setting rotation speed Ns that has been selected with the rotation speed selector 6. The prime mover control circuitry 3 controls the prime mover 2, such that the rotation speed N measured by the rotation speed sensor is adjusted to the setting rotation speed Ns.

Also, when the hydraulic pump 11 is not supplying the hydraulic liquid to the hydraulic actuator 14, the prime mover control circuitry 3 controls the prime mover 2 such that the prime mover 2 performs idling operation. The idling operation is the operation in which the rotation speed N of the prime mover 2 is kept lower than the setting rotation speed Ns. In the present embodiment, the idling operation includes low idling operation and high idling operation. In the low idling operation, the rotation speed is relatively low, whereas in the high idling operation, the rotation speed is relatively high. However, it is not essential for the prime mover 2 to perform the idling operation.

When the above-described operator is in the state of being operated, the pump control circuitry 5 transmits a being-operated signal to the prime mover control circuitry 3. During the idling operation of the prime mover 2, upon receiving the being-operated signal, the prime mover control circuitry 3 ends the idling operation, and transitions to normal operation in which the rotation speed N of the prime mover 2 is kept to the setting rotation speed Ns. When a predetermined time has elapsed after the transmission of the being-operated signal is stopped, the prime mover control circuitry 3 transitions from the normal operation to the idling operation.

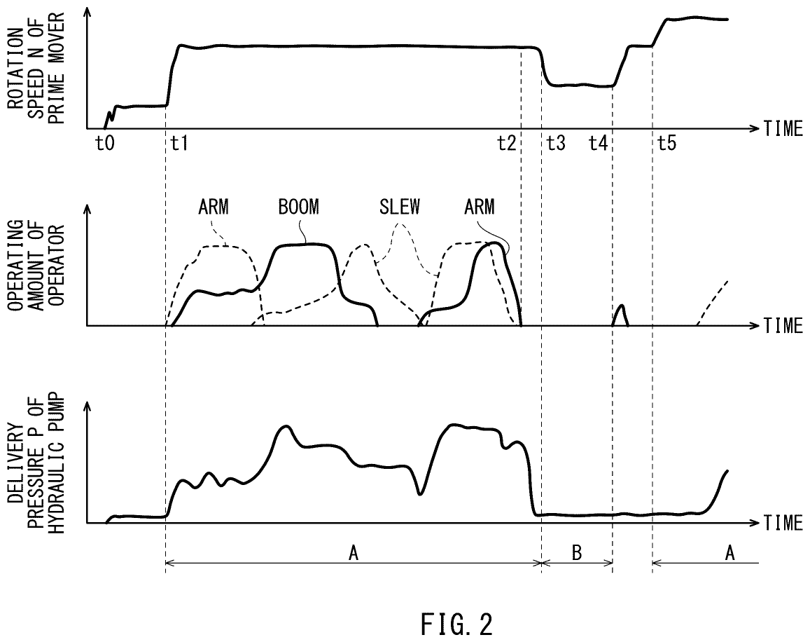

For example, FIG. 2 shows temporal changes in the rotation speed N of the prime mover 2, the operating amount of the operator, and the delivery pressure P of the hydraulic pump 11 in a case where the service life determining system 4 is mounted to a hydraulic excavator. When the prime mover 2 is started at a time to, since the minimum displacement of the hydraulic pump 1 is greater than zero as described above, the delivery pressure P of the hydraulic pump 11 rises slightly.

Immediately after the prime mover 2 is started, the prime mover control circuitry 3 performs the low idling operation. The rotation speed N of the prime mover 2 during the low idling operation (which is normally simply referred to as “idling rotation speed”) is, for example, 20 to 95% of the setting rotation speed Ns.

When the operator is operated at the time t1, the pump control circuitry 5 transmits a being-operated signal to the prime mover control circuitry 3, and the prime mover control circuitry 3 transitions from the low idling operation to the normal operation. Also, the pump control circuitry 5 controls the regulator 12 in accordance with the operating amount of the operator.

When all of the operators stop being operated at the time t2, the pump control circuitry 5 stops the transmission of being-operated signals to the prime mover control circuitry 3. After the transmission of the being-operated signals is stopped, when a predetermined time has elapsed to reach a time t3, the prime mover control circuitry 3 transitions from the normal operation to the high idling operation (in other words, the idling operation is started again). The rotation speed N of the prime mover 2 during the high idling operation is higher than the rotation speed N during the low idling operation, and is, for example, 25 to 95% of the setting rotation speed Ns.

When any operator is operated at a time t4, the pump control circuitry 5 transmits a being-operated signal to the prime mover control circuitry 3, and the prime mover control circuitry 3 transitions from the high idling operation to the normal operation.

Thereafter, for example, when a higher setting rotation speed Ns is selected with the rotation speed selector 6 at a time t5, the pump control circuitry 5 inputs the selected setting rotation speed Ns to the prime mover control circuitry 3, and the prime mover control circuitry 3 controls the prime mover 2 based on the setting rotation speed Ns.

Next, a method by which the pump control circuitry 5 determines the service life of the hydraulic pump 11 is described in detail. Each time a predetermined period A has elapsed, the pump control circuitry 5 calculates an equivalent operating time Li of the hydraulic pump 11 in the predetermined period A based on an actual operating time Ha of the prime mover 2 in the predetermined period A; changes in the rotation speed N of the prime mover 2 in the predetermined period A; changes in the delivery pressure P of the hydraulic pump 11 in the predetermined period A; and changes in the temperature T of the hydraulic liquid in the predetermined period A.

The predetermined period A is a period from when the prime mover 2 is started or the idling operation is ended to when the prime mover 2 is stopped or the idling operation is started. That is, in FIG. 2, the first predetermined period A is from the time t1 to the time t3. The predetermined period A may be a period from when the prime mover 2 is started to when the prime mover 2 is stopped, or may be a period from when the idling operation is ended to when the idling operation is started again.

In a case where the setting rotation speed Ns of the prime mover 2 has been changed after the end of the idling operation, the pump control circuitry 5 changes the start point of the predetermined period A from the end of the idling operation to a time point when the setting rotation speed Ns of the prime mover 2 has been changed. That is, the second predetermined period A starts from the time t5.

For the calculation of the equivalent operating time Li, the pump control circuitry 5 determines a first coefficient Kn from the changes in the rotation speed N of the prime mover 2 in the predetermined period A, determines a second coefficient Kp from the changes in the delivery pressure P of the hydraulic pump 11 in the predetermined period A, and determines a third coefficient Kt from the changes in the temperature T of the hydraulic liquid in the predetermined period A. Thereafter, as shown in formula (1) below, the pump control circuitry 5 calculates the equivalent operating time Li of the hydraulic pump 11 in the predetermined period A by multiplying the actual operating time Ha of the prime mover 2 in the predetermined period A by the first coefficient Kn, the second coefficient Kp, and the third coefficient Kt. Thus, the equivalent operating time Li of the hydraulic pump 11 can be calculated with a simple formula.

$$Li = Kn \times Kp \times Kt \times Ha \qquad ( 1 )$$

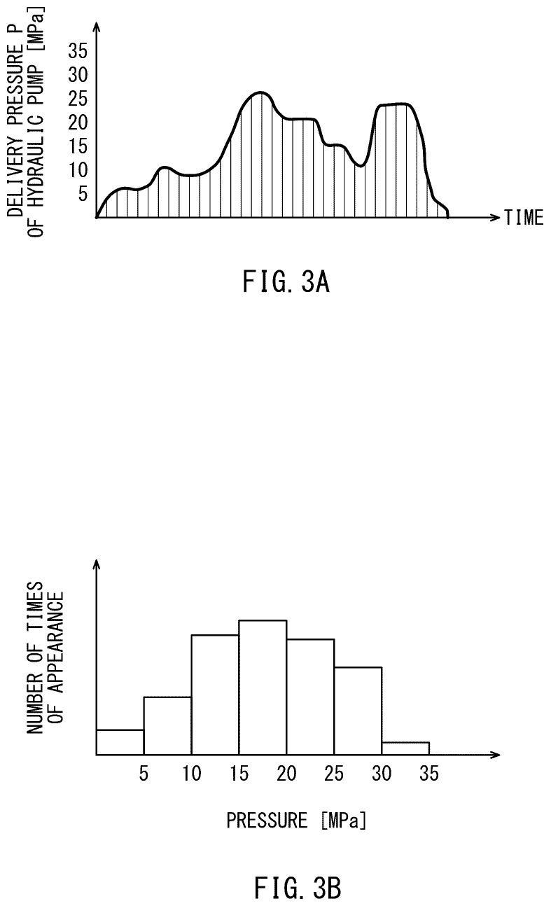

The calculation of the equivalent operating time Li of the hydraulic pump 11 is performed in a period B after the predetermined period A. After the predetermined period A, the pump control circuitry 5 converts the delivery pressure P of the hydraulic pump 11 measured during the predetermined period A by the pressure sensor 8 as shown in FIG. 3A into a histogram as shown in FIG. 3B, and stores the delivery pressure P that has been converted into the histogram. For example, the histogram in FIG. 3B is obtained by extracting, for every micro time (e.g., every 0.01 to 0.05 seconds), a pressure value from a pressure waveform shown in FIG. 3A and adding up these pressure values for each 5 MPa section.

Similarly, after the predetermined period A, the pump control circuitry 5 converts the temperature T of the hydraulic liquid measured during the predetermined period A by the temperature sensor 7 into a histogram, and stores the temperature T that has been converted into the histogram. Also, after the predetermined period A, the pump control circuitry 5 converts the rotation speed N of the prime mover 2 acquired from the prime mover control circuitry 3 during the predetermined period A into a histogram, and stores the rotation speed N that has been converted into the histogram.

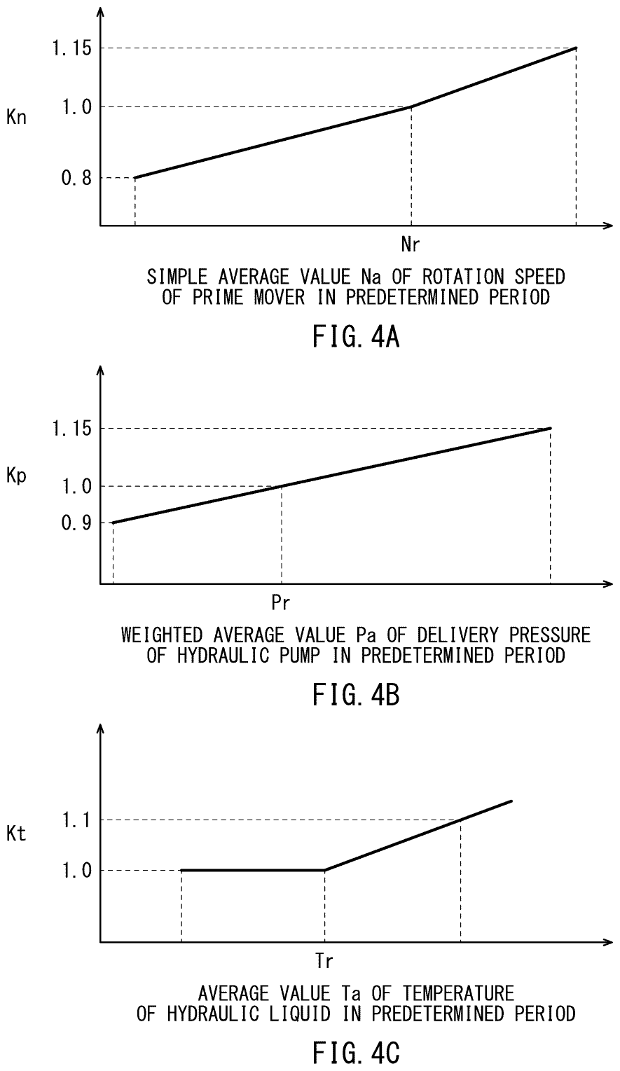

For determining the first coefficient Kn, the pump control circuitry 5 calculates a simple average value Na of the rotation speed N of the prime mover 2 in the predetermined period A. Then, as shown in FIG. 4A, in a case where the simple average value Na is equal to a reference rotation speed Nr, the pump control circuitry 5 determines the first coefficient Kn to be 1.0. In a case where the simple average value Na is less than the reference rotation speed Nr, the pump control circuitry 5 determines the first coefficient Kn to be less than 1.0, such that the less the simple average value Na, the less the first coefficient Kn. In a case where the simple average value Na is greater than the reference rotation speed Nr, the pump control circuitry 5 determines the first coefficient Kn to be greater than 1.0, such that the greater the simple average value Na, the greater the first coefficient Kn.

In FIG. 4A, the minimum value of the first coefficient Kn is 0.8, and the maximum value of the first coefficient Kn is 1.15. However, these minimum and maximum values are changeable as necessary. In FIG. 4A, a line representing the relationship between Na and Kn is a polygonal line made up of two straight lines with different slopes. Alternatively, the line representing the relationship between Na and Kn may be a single straight line, or may be a convex upward curve or a convex downward curve.

For determining the second coefficient Kp, the pump control circuitry 5 calculates a weighted average value Pa of the delivery pressure P of the hydraulic pump 11 in the predetermined period A. For example, the pump control circuitry 5 calculates the weighted average value Pa by using a formula shown below.

$$Pa = {( \frac{{P}_{1}^{10 / 3} \times {N}_{1} + {P}_{2}^{10 / 3} \times {N}_{2} + … + {P}_{n}^{10 / 3} \times {N}_{n}}{{N}_{1} + {N}_{2} + … + {N}_{n}} )}^{3 / 10} \qquad [ Math . 1 ]$$

Pn: each pressure value in the histogram of FIG. 3B.
Nn: the number of times of appearance of each pressure value in the histogram of FIG. 3B.
   The exponent of Pn need not be 10/3, but may be 3. In this case, the exponent of the above entire formula is 1/3.

Then, as shown in FIG. 4B, in a case where the weighted average value Pa is equal to a reference delivery pressure Pr, the pump control circuitry 5 determines the second coefficient Kp to be 1.0. In a case where the weighted average value Pa is less than the reference delivery pressure Pr, the pump control circuitry 5 determines the second coefficient Kp to be less than 1.0, such that the less the weighted average value Pa, the less the second coefficient Kp. In a case where the weighted average value Pa is greater than the reference delivery pressure Pr, the pump control circuitry 5 determines the second coefficient Kp to be greater than 1.0, such that the greater the weighted average value Pa, the greater the second coefficient Kp.

In FIG. 4B, the minimum value of the second coefficient Kp is 0.9, and the maximum value of the second coefficient Kp is 1.15. However, these minimum and maximum values are changeable as necessary. In FIG. 4B, a line representing the relationship between Pa and Kp is a single straight line. Alternatively, the line representing the relationship between Na and Kn may be a polygonal line made up of two straight lines with different slopes, or may be a convex upward curve or a convex downward curve.

For determining the third coefficient Kt, the pump control circuitry 5 calculates an average value Ta of the temperature of the hydraulic liquid in the predetermined period A. Then, as shown in FIG. 4C, in a case where the average value Ta is less than or equal to a reference temperature Tr, the pump control circuitry 5 determines the third coefficient Kt to be 1.0. In a case where the average value Ta is greater than the reference temperature Tr, the pump control circuitry 5 determines the third coefficient Kt to be greater than 1.0, such that the greater the average value Ta, the greater the third coefficient Tt.

In FIG. 4C, in the case of Ta≥Tr, a line representing the relationship between Ta and Kt is a single straight line. However, in the case of Ta≥Tr, the line representing the relationship between Ta and Kt may be a convex upward curve or a convex downward curve.

As described above, the service life determining system 4 of the present embodiment can calculate, for each predetermined period A, the equivalent operating time Li of the hydraulic pump 11 by taking the operating conditions of the hydraulic pump 11 into account. Accordingly, by accumulating the equivalent operating times Li of the hydraulic pump 11, the remaining service life of the hydraulic pump 11 can be recognized accurately.

For example, each time the predetermined period A has elapsed, the pump control circuitry 5 may calculate a remaining service life time La of the hydraulic pump 11 after the predetermined period A by subtracting the equivalent operating time Li from a remaining service life time Lb of the hydraulic pump 11 before the predetermined period A, as in a formula (2) shown below.

$$La = Lb - Li \qquad ( 2 )$$

According to this configuration, each time the predetermined period A has elapsed, the remaining service life time of the hydraulic pump 11 can be updated.,

Further, in the present embodiment, the predetermined period A is a period from when the prime mover 2 is started or the idling operation is ended (there is a case where the setting rotation speed Ns of the prime mover 2 is changed after the idling operation is ended; in this case, from when the setting rotation speed of the prime mover 2 is changed) to when the prime mover 2 is stopped or the idling operation is started. Accordingly, a period during which the hydraulic pump 11 supplies the hydraulic liquid to the hydraulic actuator 14 can be set as the predetermined period A. After the predetermined period A, during the idling operation or during the prime mover 2 being stopped, data measured during the predetermined period A can be processed. This advantageous effect can be similarly obtained in a case where the predetermined period A is a period from when the prime mover 2 is started to when the prime mover 2 is stopped, and also in a case where the predetermined period A is a period from when the idling operation is ended to when the idling operation is started again.

### (Variations)

The present disclosure is not limited to the above-described embodiment. Various modifications can be made without departing from the scope of the present disclosure.

For example, the pump control circuitry 5 may store the delivery pressure P of the hydraulic pump 11 measured during the predetermined period A as it is. In this case, however, the amount of data to be stored is vast. On the other hand, in the above-described embodiment, the pump control circuitry 5 converts the delivery pressure P of the hydraulic pump 11 in each predetermined period A into a histogram, and stores the delivery pressure P that has been converted into the histogram. In this manner, the amount of data to be stored can be reduced.

Further, the calculation of the equivalent operating time Li of the hydraulic pump 11 may be performed with a formula (3) shown below.

$$Li = Kn \times Kp \times Kt \times Kw \times Ko \times Kc \times Ha \qquad ( 3 )$$

In the formula (3), a fourth coefficient Kw, a fifth coefficient Ko, and a sixth coefficient Kc are used in addition to the aforementioned first coefficient Kn, second coefficient Kp, and third coefficient Kt. The fourth coefficient Kw is a damage coefficient that is determined from information relating to warm-up operation (i.e., operation to warm up the machine after the prime mover 2 is started until the hydraulic actuator 14 is operated) (the information relating to the warm-up operation is, for example, a warm-up operation time). In a case where the warm-up operation is performed properly, the fourth coefficient Kw is 1.0, whereas in a case where the warm-up operation is not properly performed, the fourth coefficient is less than 1.0. The fifth coefficient Ko is a damage coefficient that is determined from a replacement history of the hydraulic liquid. The sixth coefficient Kc is a damage coefficient that is determined from the amount of impurity in the hydraulic liquid (the amount of impurity is measured by a contamination sensor). One of or some of the fourth, fifth, and sixth coefficients Kw, Ko, and Kc need not be adopted.

Further, the pump control circuitry 5 may calculate the equivalent operating time Li of the hydraulic pump 11 in the predetermined period A not only based on the actual operating time Ha of the prime mover 2 in the predetermined period A, changes in the rotation speed N of the prime mover 2 in the predetermined period A, changes in the delivery pressure P of the hydraulic pump 11 in the predetermined period A, and changes in the temperature T of the hydraulic liquid in the predetermined period A, but also based on, for example, changes in the coolant temperature of the prime mover 2 in the predetermined period A, the replacement interval of lubricating oil of the prime mover 2, and information outputted from a lubricating oil contamination sensor. This configuration can be combined with the aforementioned fourth coefficient Kw, fifth coefficient Ko, and sixth coefficient Kc.

### SUMMARY

The present disclosure provides a system for determining a service life of a hydraulic pump driven by a prime mover, the system including: pump control circuitry that calculates, each time a predetermined period has elapsed, an equivalent operating time of the hydraulic pump in the predetermined period based on an actual operating time of the prime mover in the predetermined period, a change in a rotation speed of the prime mover in the predetermined period, a change in a delivery pressure of the hydraulic pump in the predetermined period, and a change in a temperature of a hydraulic liquid in the predetermined period.

According to the above configuration, for each predetermined period, the equivalent operating time of the hydraulic pump can be calculated by taking the operating conditions of the hydraulic pump into account. Accordingly, by accumulating the equivalent operating times of the hydraulic pump, the remaining service life of the hydraulic pump can be recognized accurately.

The hydraulic pump may supply the hydraulic liquid to at least one hydraulic actuator. The prime mover may perform idling operation when the hydraulic pump is not supplying the hydraulic liquid to the at least one hydraulic actuator. The predetermined period may be a period from when the prime mover is started or the idling operation is ended to when the prime mover is stopped or the idling operation is started again. Alternatively, the predetermined period may be a period from when the prime mover is started to when the prime mover is stopped, or may be a period from when the idling operation is ended to when the idling operation is started again. According to these configurations, a period during which the hydraulic pump supplies the hydraulic liquid to the hydraulic actuator can be set as the predetermined period. Also, after the predetermined period, during the idling operation or during the prime mover being stopped, data measured during the predetermined period can be processed.

For example, in a case where a setting rotation speed of the prime mover has been changed after an end of the idling operation, the pump control circuitry may change a start point of the predetermined period from the end of the idling operation to a time point when the setting rotation speed of the prime mover has been changed.

Each time the predetermined period has elapsed, the pump control circuitry may calculate a remaining service life time of the hydraulic pump after the predetermined period by subtracting the equivalent operating time from a remaining service life time of the hydraulic pump before the predetermined period. According to this configuration, each time the predetermined period has elapsed, the remaining service life time of the hydraulic pump can be updated.

The pump control circuitry may: determine a first coefficient from the change in the rotation speed of the prime mover in the predetermined period, determine a second coefficient from the change in the delivery pressure of the hydraulic pump in the predetermined period, and determine a third coefficient from the change in the temperature of the hydraulic liquid in the predetermined period; and calculate the equivalent operating time of the hydraulic pump in the predetermined period by multiplying the actual operating time of the prime mover in the predetermined period by the first coefficient, the second coefficient, and the third coefficient. According to this configuration, the equivalent operating time of the hydraulic pump can be calculated with a simple formula.

For example, the actual operating time and the rotation speed of the prime mover may be inputted to the pump control circuitry from prime mover control circuitry that controls the prime mover, and the above-described service life determining system may further include: a pressure sensor that measures the delivery pressure of the hydraulic pump; and a temperature sensor that measures the temperature of the hydraulic liquid.

After the predetermined period, the pump control circuitry may convert the delivery pressure of the hydraulic pump measured during the predetermined period by the pressure sensor into a histogram, and store the delivery pressure that has been converted into the histogram. If the delivery pressure measured during the predetermined period is stored as it is, the amount of data to be stored is vast. In this respect, according to the above configuration, the measured delivery pressure is converted into a histogram for each predetermined period, and then the delivery pressure that has been converted into the histogram is stored. In this manner, the amount of data to be stored can be reduced.

1. A system for determining a service life of a hydraulic pump driven by a prime mover, the system comprising:
pump control circuitry that calculates, each time a predetermined period has elapsed, an equivalent operating time of the hydraulic pump in the predetermined period based on an actual operating time of the prime mover in the predetermined period, a change in a rotation speed of the prime mover in the predetermined period, a change in a delivery pressure of the hydraulic pump in the predetermined period, and a change in a temperature of a hydraulic liquid in the predetermined period.

2. The system for determining a service life of a hydraulic pump according to claim 1, wherein
the hydraulic pump supplies the hydraulic liquid to at least one hydraulic actuator,
the prime mover performs idling operation when the hydraulic pump is not supplying the hydraulic liquid to the at least one hydraulic actuator, and
the predetermined period is a period from when the prime mover is started or the idling operation is ended to when the prime mover is stopped or the idling operation is started.

3. The system for determining a service life of a hydraulic pump according to claim 1, wherein
the hydraulic pump supplies the hydraulic liquid to at least one hydraulic actuator,
the prime mover performs idling operation when the hydraulic pump is not supplying the hydraulic liquid to the at least one hydraulic actuator, and
the predetermined period is a period from when the prime mover is started to when the prime mover is stopped, or is a period from when the idling operation is ended to when the idling operation is started again.

4. The system for determining a service life of a hydraulic pump according to claim 2, wherein
in a case where a setting rotation speed of the prime mover has been changed after an end of the idling operation, the pump control circuitry changes a start point of the predetermined period from the end of the idling operation to a time point when the setting rotation speed of the prime mover has been changed.

5. The system for determining a service life of a hydraulic pump according to claim 1, wherein
each time the predetermined period has elapsed, the pump control circuitry calculates a remaining service life time of the hydraulic pump after the predetermined period by subtracting the equivalent operating time from a remaining service life time of the hydraulic pump before the predetermined period.

6. The system for determining a service life of a hydraulic pump according to claim 1, wherein
the pump control circuitry:
determines a first coefficient from the change in the rotation speed of the prime mover in the predetermined period, determines a second coefficient from the change in the delivery pressure of the hydraulic pump in the predetermined period, and determines a third coefficient from the change in the temperature of the hydraulic liquid in the predetermined period; and
calculates the equivalent operating time of the hydraulic pump in the predetermined period by multiplying the actual operating time of the prime mover in the predetermined period by the first coefficient, the second coefficient, and the third coefficient.

7. The system for determining a service life of a hydraulic pump according to claim 1, wherein
the actual operating time and the rotation speed of the prime mover are inputted to the pump control circuitry from prime mover control circuitry that controls the prime mover, and
the system further comprises:
a pressure sensor that measures the delivery pressure of the hydraulic pump; and
a temperature sensor that measures the temperature of the hydraulic liquid.

8. The system for determining a service life of a hydraulic pump according to claim 7, wherein
after the predetermined period, the pump control circuitry converts the delivery pressure of the hydraulic pump measured during the predetermined period by the pressure sensor into a histogram, and stores the delivery pressure that has been converted into the histogram.
